(19) United States
(12) Patent Application Publication
(10) Pub. No.: US 2002/0080111 A1
(43) Pub. Date: Jun. 27, 2002

(54) Method and apparatus to input and output haptic data

(76) Inventors: Adam T. Lake, Beaverton, OR (US); Christopher B. Wilkerson, Portland, OR (US); Charles M. Forest, Hillsboro, OR (US); John A. Miller, Beaverton, OR (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/752,588

(22) Filed: Dec. 27, 2000

(51) Int. Cl. G09G 5/00

(52) U.S. Cl. 345/156

(57) ABSTRACT

Apparatus and methods are disclosed for inputting and rendering haptic data. Wherein, a haptel generates a signal in response to subjecting the haptel to a stimulus.

### FIELD OF THE INVENTION

The present invention relates to the field of haptels and methods for inputting and rendering haptic data.

### BACKGROUND OF THE INVENTION

When living beings are not within arms reach of each other, communication is limited to non-touch forms. Telephones provide audio communication over great distances, to assist the sense of hearing. Television and computer monitors have been developed to provide data in the form of a visual display. Examples of these prior art communication devices are shown in FIG. 1. FIG. 1 depicts prior art audio data transmission via telephone communication and visual data transmission and display on a computer monitor. With reference to FIG. 1, person 2 uses telephone 2a to communicate over signal path 10 with person 4 via telephone 4a. In a similar manner person 6 uses computer 6a to communicate over signal path 10 with person 8, via computer 8a. Computer 6a and 8a could be any type of prior art device that displays alphanumeric or graphic data. These prior art communication devices do not provide touch based (haptic) data input and output.

When living beings are proximate to each other, other forms of communication, beyond speaking, are employed. In particular, living beings communicate with their sense of touch. Physical contact, caressing, holding, squeezing, contact-examination are some of the forms of communication that living beings routinely employ when proximate to each other. FIG. 2 displays some of the touch-based forms of communication intended by a haptel. With reference to FIG. 2, touch 20 is indicated with two people. Holding 22 is indicated with one person's hand on another. Examination 24 involves touch-based contact as shown in FIG. 2.

A child's toy, “a set of nails,” is a device that records the imprint of a user's hand or other object that is pressed against it. This device does not provide electrical signals that can be used to reproduce the imprint on a second device, nor does this device provide the ability to configure itself based on an external input.

A prior art rendering device that allows a blind person to read brail is a binary device that can be electronically driven. What the prior art does not provide is real-time haptic data input and output that can be used to create virtual touch and telepresence of living beings or objects that are not in direct contact with each other. What is needed are haptic input output devices so that haptic data can be transmitted and rendered.

### BRIEF DESCRIPTION OF THE DRAWINGS

The present invention is illustrated by way of example and is not limited in the figures of the accompanying drawings, in which like references indicate similar elements.

FIG. 1 depicts prior art audio data transmission via telephone communication and visual data transmission and display on a computer monitor.

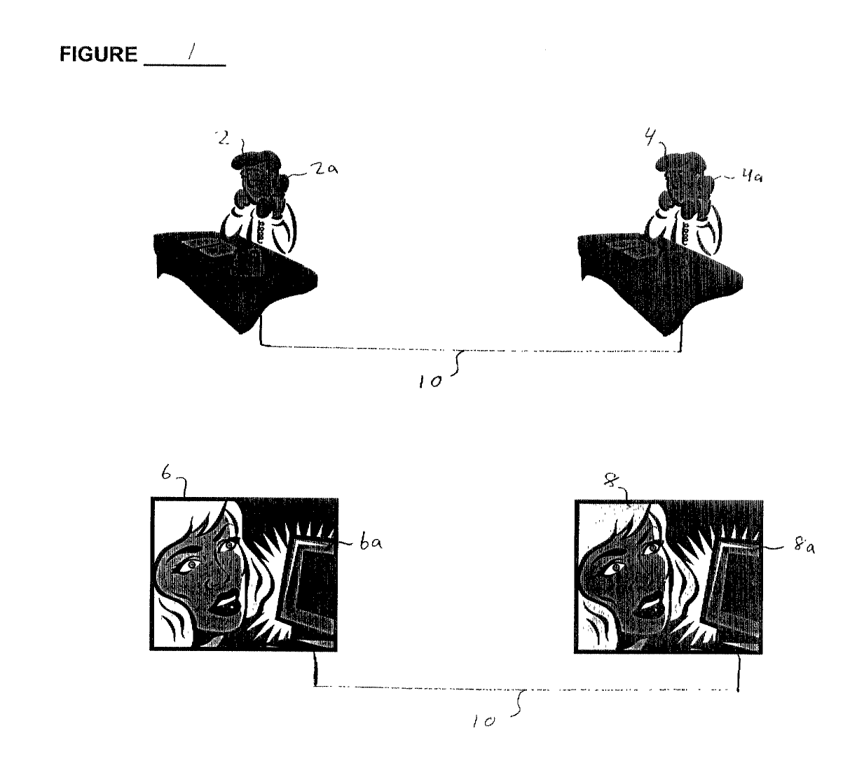

FIG. 2 displays some of the other forms of communication intended by haptels.

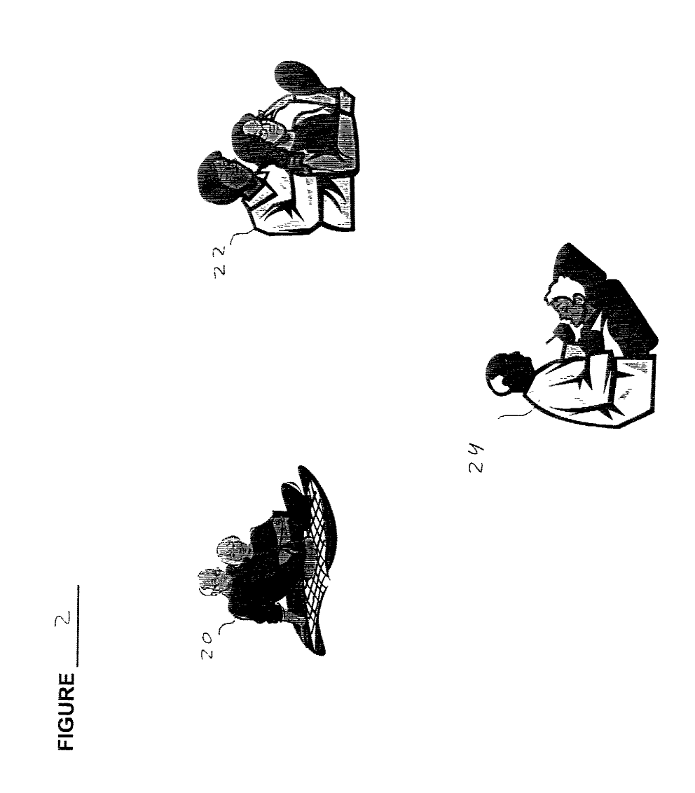

FIG. 3 displays the input and output functions of a haptel.

FIG. 4 displays a haptel that combines input and output functions into one device.

FIG. 5 shows a user feeling the surface of an array of haptels.

FIG. 6 depicts virtual real-time touch and tickling of a baby's foot.

FIG. 7 displays an array of haptels configured with amplifiers, analogue to digital converters and a haptel memory buffer.

FIG. 8 shows a network of N HRDs.

### DETAILED DESCRIPTION

A haptel and haptic rendering device (HRD) are disclosed, which allow a user to virtually feel the texture of an environment or virtually touch another person's hand that lives on the other side of the continent. Haptel refers to a single haptic element. An HRD comprises one or more haptels, which will provide the user with the ability to feel a surface, object or another user. In the following detailed description, numerous specific details are set forth in order to provide a thorough understanding of the present invention. However, it will be apparent to one of ordinary skill in the art that these details need not be used to practice the present invention. In other circumstances, well-known structures, materials, circuits, processes and interfaces have not been shown or described in detail so that the present invention is not unnecessarily obscured.

A haptel may be used for both inputting and outputting haptic data. Haptic data may be any data, which defines the ontology of an object. Some examples of haptic data are coordinates that define spatial position, velocity, temperature, force, and pressure. Indirect forms of haptic data may be emotions, such as joy, or anger.

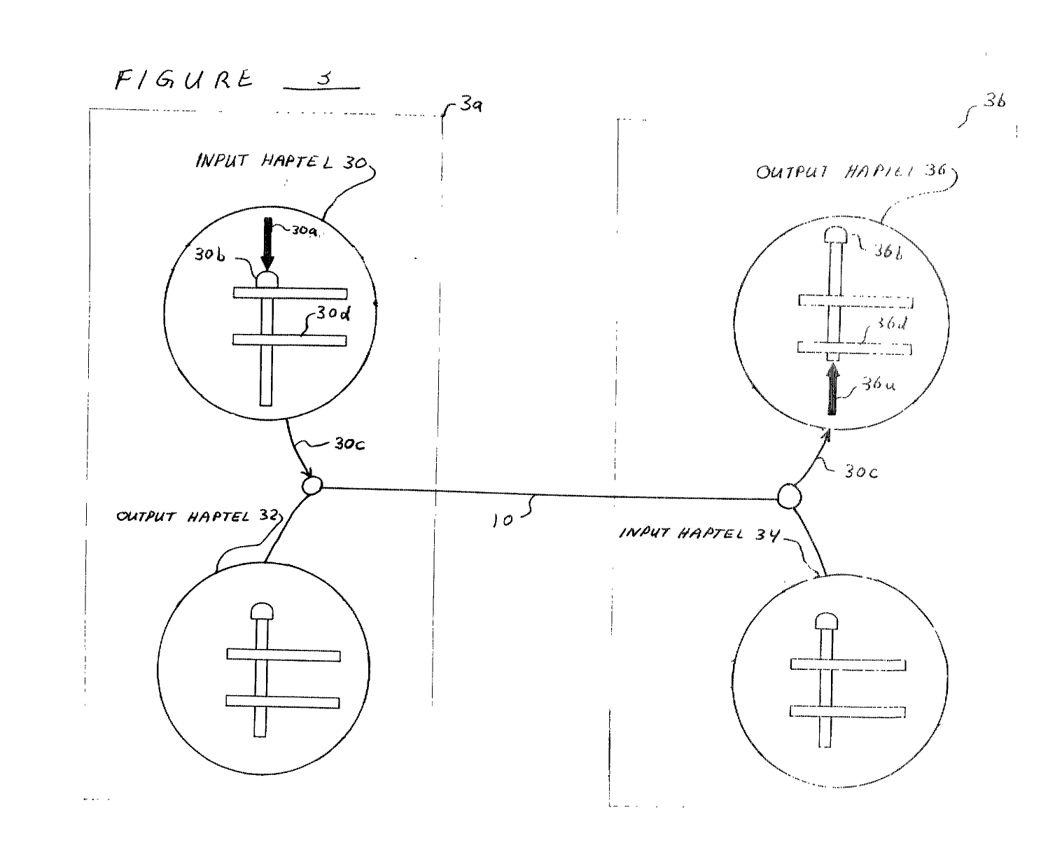

In one embodiment of the present invention, input and output functions of a haptel may be performed in separate devices. With reference to FIG. 3, a first user might have access to input haptel 30 and output haptel 32, while at another location a second user might have access to input haptel 34 and output haptel 36. The two users would be separated from each other, while the haptels were connected by signal path 10. User 1 would apply stimulus 30a to haptel element 30b such that signal 30c would be generated by input haptel 30. Signal 30c could travel through signal path 10 and be received and displayed on output haptel 36. Signal 30c might cause output haptel 36 to generate stimulus 36a resulting in signal 30c being rendered on haptel element 36b. In a similar manner, although not shown on FIG. 3, is the concurrent ability for user 2 to generate a signal with input haptel 34 that would be rendered or displayed on output haptel 32, which could be read by user 1.

For the purposes of illustration, haptel element 30b and 36b, in FIG. 3, are depicted as pins, which may move up and down in frame 30d and 36d, respectively. Many alternative mechanisms may be employed according to the present invention to serve as a haptel. For example, a piston may be moved up and down relative to a cylinder due to the expansion and contraction of a material contained within the cylinder. The material contained within the cylinder may be a fluid, a gel, a crystal, or any material that exhibits a change in volume due to an applied stimulus. For example, when using a material that exhibits a volume change in response to an applied electric field, a piston is move a distance proportional to the amount of current applied.

Another way in which the haptel could be actuated is through the use of hydraulics to move each haptel element. Alternatively, another method is to create a magnetic current for the haptel by running a wire around a region of the haptel to create a coil and move the haptel element by charging the coil. Yet another way of actuating the haptel element could be through the use of small motors. Many configurations of drive mechanisms are possible for the haptel element. The distance that the haptel element may travel is a function of a particular design and is not limited by the present invention. Distances on the order of four to eight centimeters are contemplated for certain applications, however, much larger or smaller distances might be used depending on the values of the haptic data that the user wished to display.

Temperature might be displayed on the haptic element by the use of thermoelectric heating or cooling devices to display the temperature of a surface. While the haptic element has been depicted as a pin, in FIG. 3, the present invention is not so limited. Haptic elements may be configured as desired according to the data the user wishes to display. In some instances the haptic element may be configured as a pad, which is sensitive to pressure. The haptel may be configured in many embodiments without departing from the spirit of the present invention.

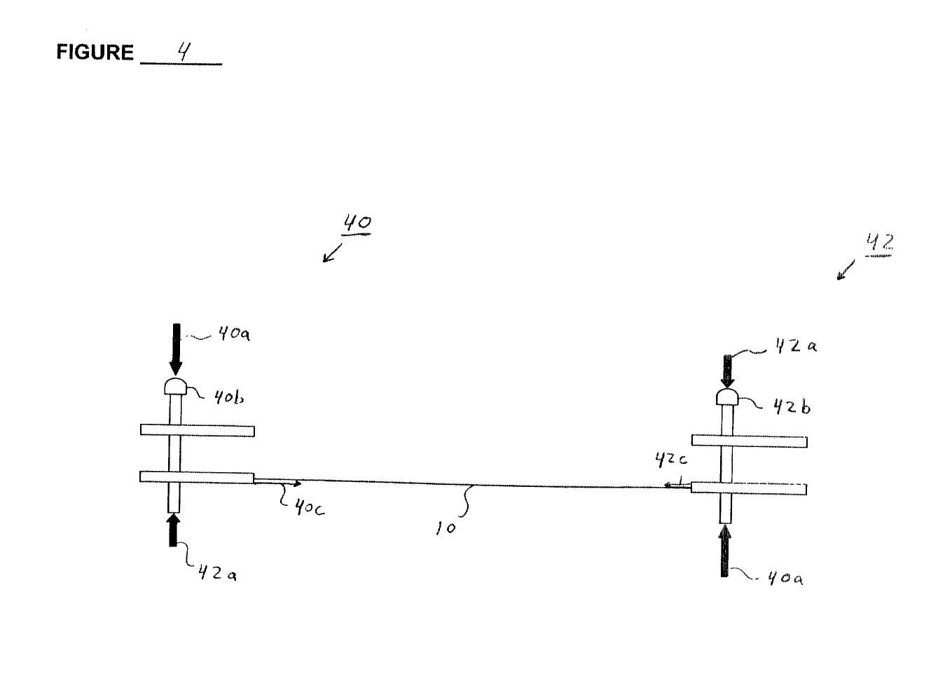

In another embodiment, of the present invention, the haptel may be configured to provide both input and output functions within a single device. With reference to FIG. 4, input/output (I/O) haptel 40 is connected via signal path 10 with I/O haptel 42. An I/O haptel combines the ability to both display haptic data and input haptic data within a given device. By way of illustration, haptic data in the form of force is indicated by the length of the arrows used in FIG. 4; input force 40a is larger than output force 42a.

User 1 pushes on I/O haptel 40, applying input force 40a to haptel element 40b. Signal 40c is generated in response to input force 40a. Signal 40c arrives at I/O haptel 42, by way of signal path 10. At I/O haptel 42, force 40a is reproduced in response to signal 40c and is imparted to haptel element 42b.

Similarly user 2 pushes on I/O haptel 42 by applying force 42a to haptel element 42b. Signal 42c is generated in response to input force 42a. Signal 42c arrives at I/O haptel 40 by way of signal path 10. At I/O haptel 40, force 42a is reproduced in response to signal 42c and is imparted to haptel element 40b.

In real time, user 1 pushes against force 42a. Force 42a is displayed on I/O haptel 40 while being simultaneously generated by user 2 with I/O haptel 42. Thus, user 1 experiences the virtual “push” of user 2 on I/O haptel 40. Since force 40a has been arbitrarily chosen to be larger than force 42a, user 1 will be able to overcome the push of user 2, thereby moving haptel element 40b down in the direction indicated by input force 40a.

The corresponding display of haptic data will occur on I/O haptel 42. User 2 will feel the virtual “push” manifested by input force 40a as input force 40a is displayed on I/O haptel 42. Force 42a imparted by user 2 to haptel element 42b is smaller than force 40a displayed on I/O haptel 42, therefore user2 will be overcome by input force 40a as haptel element 42b is moved up in the direction indicated by input force 40a on I/O haptel 42.

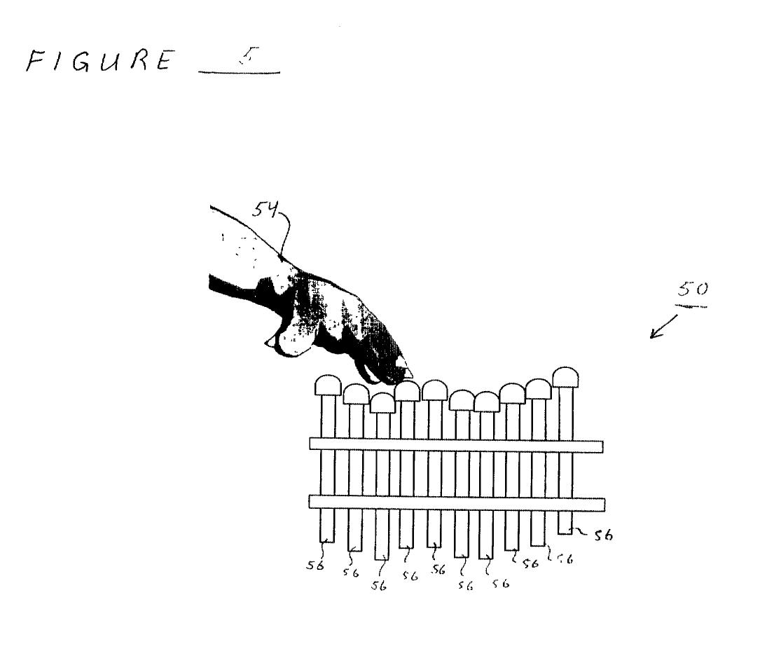

In another embodiment, of the present invention, a group of haptels may be placed together to create an array of haptels which define a surface or a geometric shape. With reference to FIG. 5, a user is shown feeling the surface of an array of haptels. User's hand 54 is shown reading the haptic data displayed on array 50. A user can see and feel the surface of array 50. The surface of a haptic array can display any form of haptic data desired. The configuration of the array of haptels may take on any desired two or three-dimensional shape.

For example, a haptel array could be configured as a ball that a user would squeeze or a glove into which a user would insert his hand that the haptel array would then squeeze, in this way users could virtually hold hands. Many configurations of a haptel array are possible; those that are mentioned in this detailed description are but a few and are not to be construed as limitations on the configurations that are possible.

The previous discussion, directed to FIG. 4, concerned an I/O haptel configured to read and display force. However I/O haptels may be configured as required to read and display other forms of haptic data. For example, an array of haptels forming a surface could change relative to the dance of a virus in a scanning electron microscope or the discrete gray scale values in an image. Haptel elements 56 could be positioned to different levels to symbolize bold or italic text from a source of alpha numeric or graphic data, such as a web page, document, or spreadsheet. Communication between users of haptels provides a form of telepresence between the users that has not been possible with prior art communication devices.

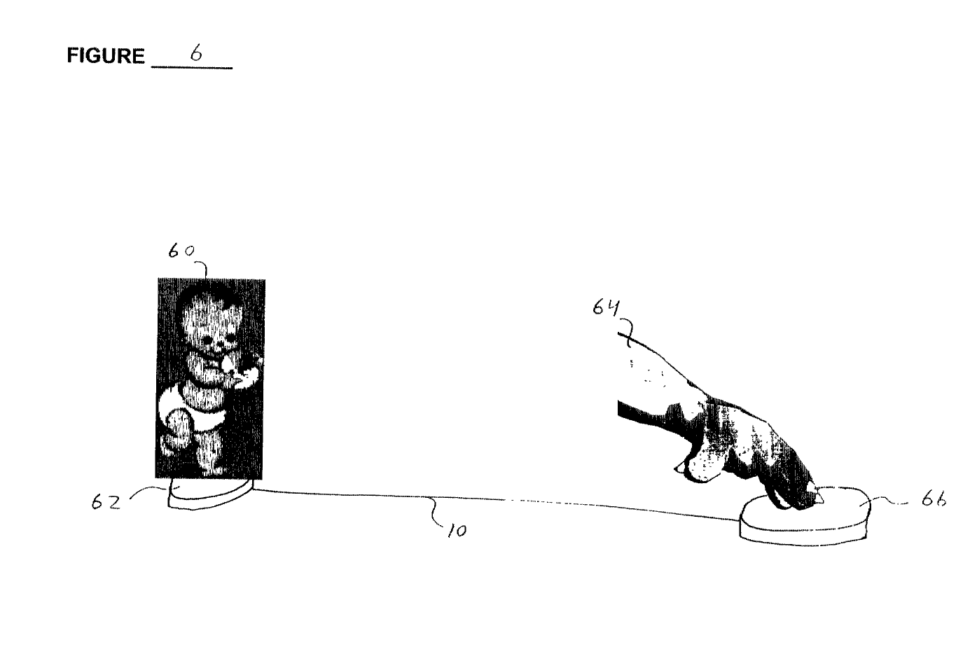

An example of communicating telepresence is displayed in FIG. 6. With reference to FIG. 6 a real-time virtual ability to tickle a baby's foot is demonstrated. Haptel array 66 and haptel array 62 could be configured as separate input and output devices, as shown in FIG. 3, or combined I/O devices, as shown in FIG. 4. Grandmother's hand 64 inputs haptic data into haptel array 66, which is communicated to haptel array 62 via signal path 10. Baby 60 places her foot on haptel array 62 and can virtually “feel” grandmother's hand 64 tickle her foot as haptic data is displayed onto haptel array 62.

Signal path 10 may be any type of information transmission system configured to transmit and receive data. For example, haptic data may be sent over the Internet, or a wide area network to a user's home via a personal computer (PC). The PC unpacks the data and updates the haptel array to reflect the new information. The amount of data for a full haptel array update is approximately equivalent to an amount of data required to render a gray scale image with the same number of pixels as haptels within the haptel array. Haptels may be configured for use with the pointing device used with a PC, such as a mouse or may be configured as a separate I/O device, which only accepts haptic data. Additionally, haptels may be configured for use with cell phones or other information transmission apparatus.

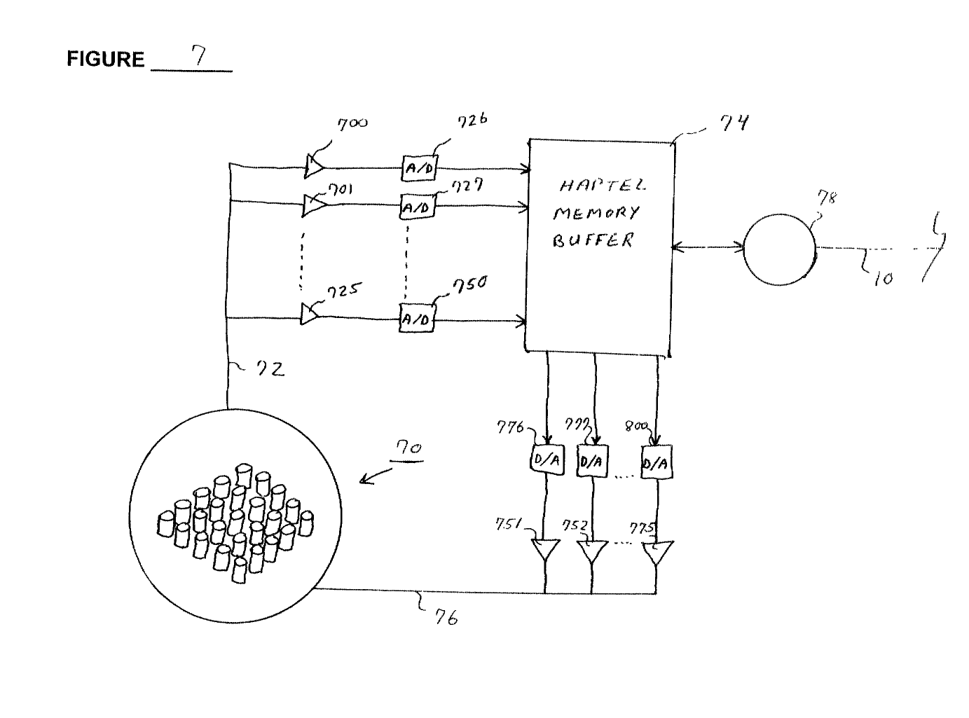

The signal path for a haptel or haptel array may be configured according to various embodiments depending on whether the haptel is an analogue or digital device or a combination of analogue and digital design sub-sections. The present invention is not limited by the embodiment chosen for the signal path. One preferred embodiment for the signal path of an array of 25 analogue I/O haptels is shown FIG. 7. The convention established to describe a signal (signal 40c FIG. 4) generated by a user inputting a force (force 40a FIG. 4), to a haptel, will be maintained in the discussion of FIG. 7. The signal arising from the user's input force will be termed the “input signal” and the signal that results in haptic data being rendered to the haptel will be termed the “output signal,” thus the use of the terms input and output define whether haptic data is being input into the haptel or being output onto the haptel.

With reference to FIG. 7, input signal path 72 directs the 25 haptel input signals, from haptel array 70, into amplifiers 700 through 725. The signal from amplifier 700 passes into analogue-to-digital converter 726 and then into haptel memory buffer 74. The signal for each individual haptel is directed similarly. Haptel memory buffer 74 allows haptic data to be transmitted by transmitter/receiver 78 onto signal path 10.

Output haptic data, coming in on signal path 10 enters into haptel memory buffer 74 and is converted to an analogue signal by digital-to-analogue converters 776 through 800. The output signals, from the digital-to-analogue converters are amplified by amplifiers 751 through 775. The output signals traverse output signal path 76 into I/O haptel array 70, where the output signals are displayed on I/O haptel array 70.

Haptel memory buffer 74 may be divided into input and output portions when needed to handle the needs of both forms of data transfer. Haptic data input and output may be implemented in a way that provides a real-time telepresence as previously discussed by continuously updating the haptel.

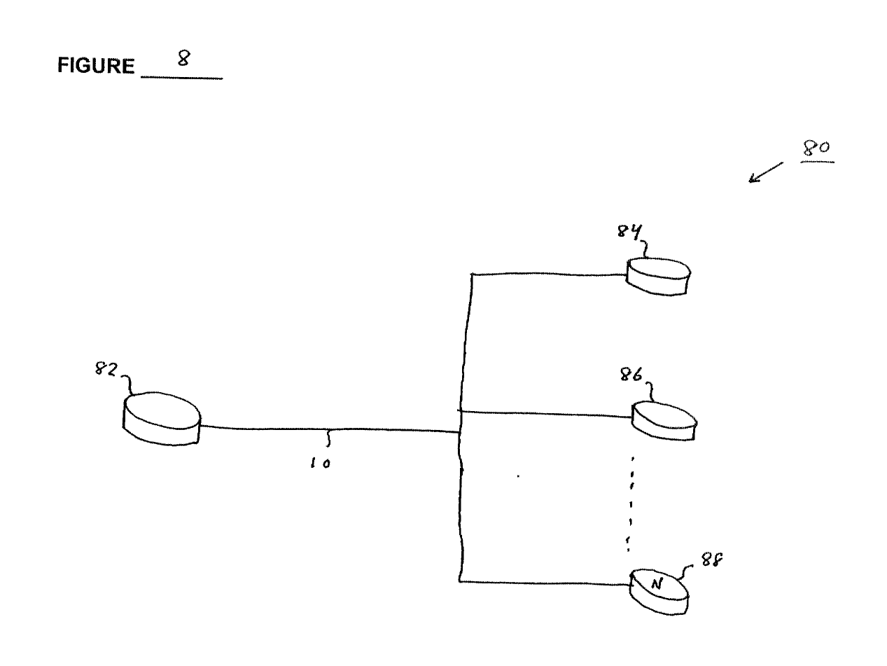

In another embodiment, of the present invention, one HRD may send haptic data to a plurality of HRDs. FIG. 8 shows a network of N HRDs. With reference to FIG. 8, HRD 82 is connected with HRD 84, HRD 86, up to a general number N of HRDs, HRD 88, via signal path 10. The HRDs shown in FIG. 8 allow haptic data, input on one HRD, to be output on the other HRDs. For example, haptic data could be input on HRD 82 and be output on HRD 84, 86, up to general number N of HRDs, HRD 88.

Other uses for haptels are envisioned. For example, the haptel could be used as an input/output device for computer games. A computer game may include doors that are activated by buttons. Haptels could be used to actuate the doors, allowing the user to push the haptel and in so doing operate the button that works in cooperation with the computer game. Another use may be in the field of computer-aided design (CAD).

A CAD designer would be able to see the 3-D representation of an object rendered on a suitable haptel display. The haptel could render the 3-D geometry of an object the designer had created with a computer graphics program and as the object rotated on the computer screen, the object rendered on the haptel array could rotate as well.

Alternatively, the haptel array could be used to read the shape of the object pressed against it. The CAD designer previously discussed could use data input into the haptel in this manner.

In the foregoing specification, the invention has been described with reference to specific embodiment thereof. It will be, however, evident that various modifications and changes may be made thereto without departing from the broader scope and spirit of the invention. The specification and drawings are, accordingly, to be regarded in an illustrative rather than restrictive sense.

What is claimed is:

1. An apparatus comprising:
a haptel wherein a signal is generated in response to subjecting said haptel to a stimulus.

2. An apparatus, as in claim 1, further comprising an array of haptels.

3. An apparatus, as in claim 1, wherein the stimulus is selected from the group consisting of spatial position, velocity, temperature, force, pressure, and emotion.

4. An apparatus, as in claim 1, wherein said haptel is configured into a computer system pointing-device.

5. An apparatus, as in claim 1, wherein said haptel is configured with an information transmission system.

6. A method comprising:
subjecting a haptel to a stimulus; and
creating a signal responsive to said subjecting.

7. An apparatus, as in claim 6, further comprising an array of haptels.

8. An apparatus, as in claim 6, wherein the stimulus is selected from the group consisting of spatial position, velocity, temperature, force, pressure, and emotion.

9. An apparatus, as in claim 6, wherein said haptel is configured into a computer system pointing-device.

10. An apparatus, as in claim 6, wherein said haptel is configured with an information transmission system.

11. An apparatus comprising:
a haptel, wherein said haptel is responsive to a signal, such that a quantity is rendered on said haptel.

12. An apparatus, as in claim 11, further comprising an array of haptels.

13. An apparatus, as in claim 11, wherein said haptel is configured into a computer system pointing-device.

14. An apparatus, as in claim 11, wherein said haptel is configured with an information transmission system.

15. An apparatus, as in claim 11, wherein the quantity is selected from the group consisting of spatial position, velocity, temperature, force, pressure, and emotion.

16. A method comprising:
receiving a signal; and
setting a haptel in response to the signal, such that a quantity is rendered on the haptel.

17. An apparatus, as in claim 16, further comprising an array of haptels.

18. An apparatus, as in claim 16, wherein the quantity is selected from the group consisting of spatial position, velocity, temperature, force, pressure, and emotion.

19. An apparatus, as in claim 16, wherein said haptel is configured into a computer system pointing-device.

20. An apparatus, as in claim 16, wherein said haptel is configured with an information transmission system.

21. An apparatus comprising:
a haptel wherein a signal is generated in response to subjecting said haptel to a stimulus;
a transmitter to transmit the signal;
a receiver to receive the signal from said transmitter; and
a haptel, wherein said haptel is responsive to the signal;
such that a quantity is rendered on said haptel, it follows from the foregoing that haptic data is transmitted.

22. An apparatus, as in claim 21, further comprising an array of haptels to create a haptel display.

23. An apparatus, as in claim 21, wherein the stimulus is selected from the group consisting of spatial position, velocity, temperature, force, pressure, and emotion.

24. An apparatus, as in claim 21, wherein said haptel is configured into a computer system pointing-device.

25. An apparatus, as in claim 21, wherein said haptel is configured with an information transmission system.

26. A method comprising:
subjecting a first haptel to a stimulus;
creating a haptel signal responsive to said subjecting;
transmitting the haptel signal;
receiving the haptel signal; and
setting a second haptel in response to the haptel signal; such that a quantity is rendered on the second haptel, it follows from the foregoing that haptic data is transmitted.

27. An apparatus, as in claim 26, further comprising an array of haptels.

28. An apparatus, as in claim 26, wherein the stimulus is selected from the group consisting of spatial position, velocity, temperature, force, pressure, and emotion.

29. An apparatus, as in claim 26, wherein said haptel is configured into a computer system pointing-device.

30. An apparatus, as in claim 26, wherein said haptel is configured with an information transmission system.

31. An apparatus comprising:
a haptel, wherein a first signal is generated in response to subjecting said haptel to a stimulus and said haptel is responsive to a second signal, such that a quantity is rendered on said haptel in response to the second signal.

32. An apparatus, as in claim 31, further comprising an array of haptels.

33. An apparatus, as in claim 31, wherein the stimulus and quantity are selected from the group consisting of spatial position, velocity, temperature, force, pressure, and emotion.

34. An apparatus, as in claim 31, wherein said haptel is configured into a computer system pointing-device.

35. An apparatus, as in claim 31, wherein said haptel is configured with an information transmission system.

36. A method comprising:
subjecting a haptel to a stimulus;
creating a first signal responsive to said subjecting;
receiving a second signal; and
setting a haptel in response to the second signal, such that a quantity is rendered on the haptel.

37. An apparatus, as in claim 36, further comprising an array of haptels.

38. An apparatus, as in claim 36, wherein the stimulus and quantity are selected from the group consisting of spatial position, velocity, temperature, force, pressure, and emotion.

39. An apparatus, as in claim 36, wherein said haptel is configured into a computer system pointing-device.

40. An apparatus, as in claim 36, wherein said haptel is configured with an information transmission system.
